(19) United States
(12) Patent Application Publication
(10) Pub. No.: US 2006/0175114 A1
(43) Pub. Date: Aug. 10, 2006

(54) Defensive electrical neural inhibitor

(76) Inventor: James Carmack Dysart, Houston, TX (US)

Correspondence Address: JAMES CARMACK DYSART;APT 1223, 8721 TOWN PARK DR., HOUSTON, TX, 77036, US

(21) Appl. No.: 11/204,070

(22) Filed: Aug. 15, 2005

Related U.S. Application Data
(60) Provisional application No. 60/601,847, filed on Aug. 16, 2004.

(51) Int. Cl. B64D 11/06; B64D 1/04; A47C 31/00; B60K 28/00

(52) U.S. Cl. 180/271; 89/1.1; 297/217.3; 244/122 R

(57) ABSTRACT

A device and method for subduing a suspect who becomes violent or aggressive while seated in a motor vehicle or aircraft. The device is comprised of a series of parallel electrodes which run under the surface of a specially modified seats, flooring, and operating surfaces. When trigged will physically restrain and deter an individual via a series of low current, high voltage pulses.

### REFERENCES CITED

I make claim to provisional patent 17541 U.S. PTO 60/601847 under James Carmack Dysart DBA Dysart Technical Studies with the device name of Defensive Electrical Neural Inhibitor and was issued Aug. 16 2004.

| | | |
|---|---|---|
| 550229 | November, 1895 | McDonald |
| 2057138 | October, 1936 | Dowell |
| 2164076 | June, 1939 | Osgood |
| 3722788 | March, 1973 | Petrerecz |
| 3803463 | April, 1974 | Cover |
| 4221480 | September, 1980 | Sears |
| 4253132 | Febrauary, 1981 | Cover |
| 4367843 | January, 1983 | Bros et al. |
| 4843371 | June, 1989 | Kuei et al. |
| 4908606 | March, 1990 | Kevonian |
| 5258741 | November, 1993 | Fuller |
| 5515032 | May, 1996 | Johnson |
| 5801617 | September, 1998 | Langner |

### BACKGROUND OF THE INVENTION

1. Field of the Invention

The invention relates to electrical discharge for subduing and detaining an individual in a seated position while in a vehicle or other mobile vehicle.

2. Background of the invention

Many time a police officer is overtaken while a suspect in the rear of the squad car or other form of transportation. In many cases it is impractical if not impossible for the officer to react with non deadly force, especially if the vehicle is in motion. The effects of using a TASER weapon is desirable because of total immobilization but the effect is short and again, nearly impossible to deploy and fire while under attack in a moving patrol car.

With the threat of terrorism a daily occurrence the same problem exists with airlines. Weapons are highly impractical on an airliner, not only for the possible damage to the aircraft if discharged, but also concerns that an attacker may gain access or use the firearm or TASER.

For example, U.S. Pat. No 5,801,617 disclose a means for electrifying steering wheels and other controls.

Yet another devices U.S. Pat. Nos. 2,186,597 and 3,722,788 respectively, disclose a means of electrifying the running boards and window ledges of an automobile.

There is clearly an increase in demand to secure the safety of not only our law enforcement officials but airline carriers as well.

### SUMMARY OF THE INVENTION

It is the principal object of the invention to immobilize and deter an hostile or threatening individual who is in a seated or standing position. A feature of the invention is delivering a non-lethal high voltage discharge to the unauthorized person seated in a so equipped chair, seat, floor, or operating surface.

### DESCRIPTION OF MATERIAL DRAWING

### D.E.N.I.

### Defensive Electrical Neural Inhibitor

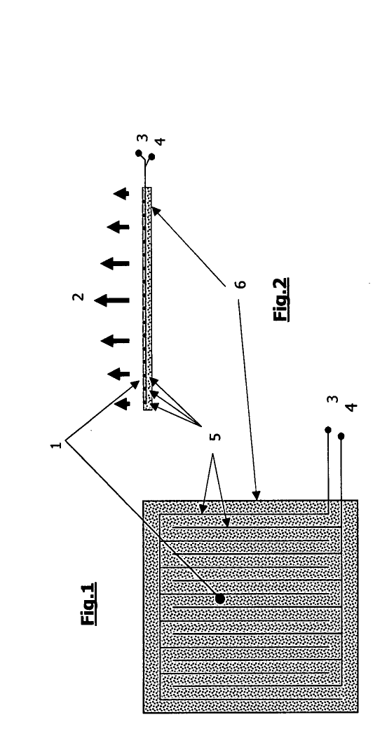

FIG. 1 (Top View)

FIG. 2 (Side View)

1). Emitting Surface

2). Direction of Discharge

3). Electrode “A” Input

4). Electrode “B” Input

5). Parallel Running Electrodes

6). Dielectric Material

I claim the embodiment of the invention in which exclusive property or privilege is claimed and defined as follows

1. A device for immobilizing an attacker with an instrument comprising:
a.) a means for delivering an electrical arc through the surface of a specially equipped seat, flooring, or operating surface wherein said electric arc is produced by a series of alternately charged electrodes.
b.) a means for imparting an electrical arc to the person seated in a specially equipped seat, flooring, or operating surface.
c.) a means for generating said electric arc manually or automatically.

2. The device as stated in claim 1 wherein said electrodes are arranged longitudinally parallel to the other.

3. The device as recited in claim 1 comprises a means of identifying an unauthorized person

4. The device as recited in claim 1 wherein an electric arc is imparted to the unauthorized person.

5. That the device as recited in claim 1 is comprised of a voltage source with a non-injuring effects.
